(19) United States
(12) Patent Application Publication
(10) Pub. No.: US 2020/0272952 A1
(43) Pub. Date: Aug. 27, 2020

(54) EVENT TICKET DISTRIBUTION MANAGEMENT USING PREDICTIVE ANALYTICS FOR IMPROVED ATTENDANCE RATE, TICKET SALES, AND SEATING ALLOCATION

(71) Applicant: TicketFire, Columbus, OH (US)

(72) Inventors: Ramon M. Shealy, Dublin, OH (US); Slater Meehan, Columbus, OH (US); Anthony Santucci, London, OH (US); Thomas Parizek, Columbus, OH (US); Daniel M. DeMato, Selden, NY (US)

(21) Appl. No.: 16/800,289

(22) Filed: Feb. 25, 2020

Related U.S. Application Data
(60) Provisional application No. 62/811,417, filed on Feb. 27, 2019.

(51) Int. Cl. G06Q 10/02; G06Q 10/04; G06N 7/00; G06F 9/54

(52) U.S. Cl. CPC G06Q 10/02; G06F 9/542; G06N 7/005; G06Q 10/04

(57) ABSTRACT

Systems and methods for managing the sale and transfer of electronic event tickets are provided. The systems and methods may use flexibility and convenience in purchasing, canceling, transferring, exchanging, and other management of electronic tickets (e.g., mobile tickets) and online payment schemes to facilitate distribution of tickets. The systems and methods may be configured to predict a number of no-shows among distributed regular tickets by using, for example, predictive analytics based on various factors such as historical data. The system and methods may be configured to distribute flexible tickets based on the prediction to fill empty seats resulting from no-shows at events.

### CLAIM OF PRIORITY

This application claims priority to U.S. Provisional Application Ser. No. 62/811,417, filed on Feb. 27, 2019, the entire contents of which are hereby incorporated by reference.

### TECHNICAL FIELD

This document describes devices, systems, and methods related to distribution of tickets to events.

### BACKGROUND

Electronic ticketing systems have been used to manage and distribute tickets to events, such as sporting events, concerts, theater productions, and other events. Electronic ticketing systems have included a variety of features for users to search for, select, and purchase tickets to events. For example, electronic ticketing systems have included online interfaces through which users are able to search for tickets to various events, to select specific tickets or seats to those events, to complete electronic ticket purchases, and to select ticket delivery methods, including mail delivery, will call, and electronic ticket distribution. Online interfaces for electronic ticketing systems have included, for example, browser-based interfaces (e.g., web pages) and mobile applications designed to be run on mobile computing devices (e.g., smartphones, tablets, smart watches, etc.). Electronic ticketing systems have permitted users to purchase tickets to events in advance of the events taking place, such as up to a threshold amount of time prior to the event (e.g., able to purchase tickets up to 1 hour before event). Electronic ticketing systems have been partnered with event providers to make tickets available to select groups of users (e.g., members) and/or the general public for the sale and distribution of tickets.

Secondary market electronic ticketing systems have also been created to permit people who have purchased tickets to events to resell those tickets to other users. Such secondary market electronic ticketing systems have included similar online interfaces through which users are able to search for, select, and purchase tickets, as well as interfaces through which ticket holders are able to list their tickets for resale. Secondary market electronic ticketing systems have similarly permitted purchase of tickets in advance of an event taking place.

### SUMMARY

The present disclosure relates to systems and methods for managing the sale and transfer of electronic event tickets between users, particularly for managing the distribution of and assignment of flexible electronic event tickets that do not have an assigned seat when sold, but are assigned to unused seats at or around the time of an event. For example, many events (e.g., sporting events, concerts, theater productions, participation events such as marathons, triathlons, etc., and other suitable events), even sold-out events, typically have some seats (including participation openings or slots) that are left empty by “no-shows,” which are reserved or purchased tickets to events and that do not end up being used (e.g., ticket holder does not show up to event). Various reasons are behind no-shows, such as a ticketholder's plans changing at the last minute, interest in the event dropping after purchasing tickets, difficulty in traveling to the event (e.g., bad weather, traffic), losing or misplacing tickets, and/or ticketholders who received free/heavily-discounted tickets feeling little to no obligation to attend an event due to lack of financial investment. Event organizers typically expect certain percentage of seats sold go unused at a given event, even at sold-out events. However, empty seats may cause several negative effects on events, such as reducing the perceived value of performer or team at events, attendee frustration at seeing open seats that were not previously available, loss of opportunities for additional ticket sales, loss of potential customers who were unable to purchase tickets, and/or decreased incremental sales on merchandise and concessions at events. The disclosed technology can increase the attendance at events and reduce the negative impact of no-shows by providing a ticket management system that distributes and assigns flexible event tickets to seats (or other assigned locations) at events that have gone unused on a rolling basis during the event.

The disclosed technology can provide flexibility and convenience in purchasing, canceling, transferring, exchanging, and other management of electronic tickets (e.g., mobile tickets) and online payment schemes to facilitate distribution and use of flexible event tickets. However, flexible event tickets can introduce potential problems, such as overselling an event with flexible tickets, which may result in flexible ticket holder not being assigned a seat and/or overcrowding at the event. The disclosed systems and methods can avoid these (and/or other potential problems) by estimating or predicting a number of no-shows among distributed regular tickets (e.g., tickets that are distributed at predetermined regular prices) based on any of a variety of factors (e.g., event type, location, day of week, time of year, weather), and distributing (e.g., allocating, assigning, selling, etc.) flexible tickets (e.g., flex passes) in appropriate quantities so that empty seats resulting from the no-shows are filled by flexible event ticketholders without potential negative problems associated with events being oversold.

The systems and methods can analyze various factors to project expected ticket use and attendance, and issue flexible tickets (also referred to as flexible event tickets, flexible passes, flex passes, alternative tickets, or the like) to add new attendees to the events. The systems and methods use predictive analytics to predict the number of no-shows at upcoming events. In addition or alternatively, the predictive analytics can predict the likelihood of no-show for a particular seat that has been sold. Various data can be used for predictive analytics, such as historical data (e.g., historical scan data, historical sales data, historical no-shows rate or average attendance per event type, seat location, etc.), patron information (e.g., corporate seating, season ticketholder, etc.), time of the event (e.g., time, week, day, etc.), demand, industry trends, weather, and other relevant information.

In some implementations, the systems and methods disclosed herein can predict one or more no-shows among the regular tickets that have been distributed. For example, a number of no-shows can be estimated or predicted from the distributed regular tickets. In addition or alternatively, one or more particular regular tickets that are likely to become no-shows can be predicted. Various algorithms may be used to estimate or predict no-shows among the distributed regular tickets. The technology disclosed herein can use historical data relating to the subject event or similar events, such as historical ticket sales, historical ticket scans, historical attendance and/or no-show rates, and predict a number of no-shows at the subject event. In addition or alternatively, the technology disclosed herein can use more sophisticated predictive analytics to predict the number of no-shows at the event and/or particular seats that are likely to go unused. Such predictive analytics may use not only historical data but other suitable data such as ticket types (e.g., corporate seating, season ticketholder, etc.), customer information, date/time of the event, venue of the event, ticket demand, industry trends, weather, and other relevant information.

Flexible tickets may be sold at various times ahead of the events and at discounted prices. However, flexible tickets may not have specific seat assignments until a predetermined time before or after an event starts, such as a time shortly before or shortly after the event is about to start. In some instances, flexible tickets may have a plurality of tiers that may be classified by one or more categories, such as different prices, different seat types (e.g., premium, donor, club member, suite, and fan club), different seat locations (e.g., zones or sections), and different transaction types (e.g., online, in person, solicited or unsolicited, and payment methods). By way of example, the tiers of flexible tickets may be determined by different seat locations (e.g., zones or sections) from which no-show tickets are identified or predicted for an event. If no-shows are identified or predicted from a particular seat zone or section, flexible tickets may be distributed for that particular seat zone or section. In addition or alternatively, the tiers of flexible tickets may be determined by different ticket price ranges.

Flexible tickets may be subject to seat assignments that can change during the event depending on the real-time status of ticket use and attendance. For example, a flexible ticket that has been assigned to a particular seat may be reassigned to a different seat if the real-time ticket scan indicates that the regular ticket for the particular seat has just been scanned. Flexible tickets may be reassigned multiple times during an event as the ticket scan data is updated in real-time. A flexible ticket for an inferior seat (e.g., a flexible ticket of an inferior tier) can be upgraded to a better seat (e.g., a seat for a ticket of a better tier) if a regular ticket for the better seat has not been scanned until a predetermined time (e.g., 5 minutes before the event begins). As the ticket scan data is updated in real-time, the flexible ticket that has been upgraded may be reassigned or downgraded to a different seat to yield the upgraded seat to the regular ticket holder who has just checked in, or to other original or flexible ticket holder who is assigned to that seat for various reasons.

The technology disclosed herein can be configured to, from among the seats that have been identified as no-shows, determine better seats and assign or reassign them to the flexible tickets so that better seats are first occupied while inferior seats (if any) are left unoccupied eventually. As such, the technology disclosed herein can prioritize no-shows seats and allocate better no-show seats to flexible tickets in real-time, thereby allowing flexible ticket holders to take better seats than other empty seats overall.

In addition or alternatively, when data is available on specific patrons who have purchased tickets to an event, the systems and methods can employ a proactive measure which uses a targeted communication to identify patrons who will not attend an event or will have a ticket go unused, thereby acquiring self-identifying no-show inventory. The systems and methods can operate to directly reach regular ticket holders to gauge which and how many seats will go unfilled, and resell the returned tickets to provide new patrons with opportunity to attend the event. In some embodiments, the regular ticket holders may be compensated for responding with their attendance status and/or returning tickets earlier. The compensation can be of various forms, such as cash or point rewards, coupons, gift certificates, etc., and can also include a waiver of any agreed fee (e.g., cancellation fee) upon returning the tickets. As such, the proactive measure can provide ticket holders with more flexibility for unexpected change of plan.

The tickets returned by regular ticket holders may be distributed in various ways. For example, the systems and methods can generate waiting lists for sold-out events, and notify potential customers of available tickets. Such a notification can be made by a targeted message sent to curated lists of customers. The tickets may be digitally distributed to customers via text message or email. Alternatively or in addition, the systems and methods can distribute the tickets on marketplaces specifically created for no-show seats, which may be strategically shared with audiences. Alternatively or in addition, the tickets may be distributed on popular secondary markets.

Particular embodiments described herein include a method for distributing digital tickets for an event. The method may include obtaining ticket sales data including a number of distributed event tickets, predicting a number of no-shows among the distributed event tickets, determining a number of flexible tickets to be distributed, the flexible tickets having no seat assignments, obtaining, from at least one event venue computing device, real-time ticket scan data including a scan status of the distributed event tickets, identifying unscanned event tickets among the distributed event tickets based on the real-time ticket scan data by a predetermined time, assigning seats for the unscanned event tickets to the flexible tickets; and transmitting a notification of the seat assignments to flexible ticketholder computing devices.

In some implementations, the system can optionally include one or more of the following features.

The prediction of a number of no-shows may include obtaining historical data including at least one of a historical number of no-shows for the event in history, estimating the number of no-shows based at least in part on the historical data.

The prediction of a number of no-shows may include obtaining event-related data, and operating a statistical analysis model based on the event-related data to predict the number of no-shows for the event.

The event-related data may include at least one of historical data relating to a subject event or similar or comparable events, ticket types, patron information, event time, event data, event venue, ticket demand, industry trends, weather information, customer origin location, current customer location, historical no-shows for repeat customers, current ticket sales figures, event and performer social media mentions, secondary marketplace demand, secondary marketplace prices, traffic, event promotions, conflicting events, and competitor pricing. The historical data may include at least one of historical ticket sales, historical ticket scans, and historical attendance and/or no-show rates.

The flexible tickets may be distributed at lower prices than the distributed event tickets.

The flexible tickets may be classified into a plurality of categories being distributed at different prices.

The flexible ticketholder computing devices may include mobile computing devices.

The notification may be in a form of text message.

The notification may be transmitted shortly before, at, or shortly after, the event starts.

The method may include determining at least one of the unscanned event tickets is scanned after the notification is transmitted, assigning other available seats to the flexible tickets, and transmitting a second notification of the seat assignment to the flexible ticketholder computing devices.

The method may include determining that upgrade seats are available after the notification is transmitted, assigning the upgrade seats to the flexible tickets, and transmitting a third notification of the seat assignment to the flexible ticketholder computing devices.

The method may include identifying at least one ticketholder of the distributed event tickets, transmitting a correspondence to at least one ticketholder computing device before the event starts, the correspondence prompting the at least one ticketholder to provide attendance status, receiving, from the at least one ticketholder computing device, identification of returned tickets among the distributed event tickets, and enabling the returned tickets available for distribution.

The method may include, upon receiving the identification of returned tickets, providing a compensation to the at least one ticketholder.

The identification of at least one ticketholder may include obtaining event-related data, and determining the at least one ticketholder that is more likely to return tickets than other ticketholders of the distributed event tickets.

The number of flexible tickets may be less than the predicted number of no-shows.

Particular embodiments described herein include a system for managing distribution of event tickets. The system may include a data processing apparatus, and a memory device storing instructions that when executed by the data processing apparatus cause the server to perform operations comprising obtaining ticket sales data including a number of distributed event tickets, predicting a number of no-shows among the distributed event tickets, determining a number of flexible tickets to be distributed, the flexible tickets having no seat assignments, obtaining, from at least one event venue computing device, real-time ticket scan data including a scan status of the distributed event tickets, identifying unscanned event tickets among the distributed event tickets based on the real-time ticket scan data by a predetermined time, assigning seats for the unscanned event tickets to the flexible tickets, and transmitting a notification of the seat assignments to flexible ticketholder computing devices.

Particular embodiments described herein include a system having an event venue server, a plurality of ticketholder computing devices, one or more flexible ticketholder computing devices, and a ticket distribution system. The event venue server may be configured to communicate one or more ticket scanners and obtain ticket scan data in real-time. The plurality of ticketholder computing devices may be each configured to receive regular ticket data and output an electronic regular ticket based on the regular ticket data. The electronic regular ticket may be configured to be scanned by the one or more ticket scanners. The flexible ticketholder computing devices may be each configured to receive flexible ticket data and output an electronic flexible ticket based on the flexible ticket data. The electronic flexible ticket may be configured to be scanned by the one or more ticket scanners. The ticket distribution system may include a data processing apparatus and a memory device storing instructions that when executed by the data processing apparatus cause the ticket distribution system to perform operations comprising obtaining ticket sales data including a number of distributed event tickets, predicting a number of no-shows among the distributed event tickets, determining a number of flexible tickets to be distributed, the flexible tickets having no seat assignments, receiving a purchase request of a flexible ticket from each of the flexible ticketholder computing devices, transmitting flexible ticket data to each of the flexible ticketholder computing devices, the flexible ticket data representing a flexible ticket identified by the purchase request, obtaining, from the event venue server, real-time ticket scan data including a scan status of the distributed event tickets, identifying an unscanned event ticket among the distributed event tickets based on the real-time ticket scan data by a predetermined time, assigning a seat for the unscanned event ticket to the flexible ticket, and transmitting a notification of the seat assignment to the flexible ticketholder computing device having the flexible ticket.

The devices, system, and techniques described herein may provide one or more of the following advantages. First, some embodiments described herein include event ticket distribution systems and methods that facilitate effective distribution of tickets to add new attendees to events at the last minutes through discounts, thereby reducing vacant seats. Some embodiments of the systems and methods are configured to predict a number of no-shows and/or no-shows for particular seats prior to an event, and additionally distribute a number of flexible tickets (e.g., flex passes) to bring in new attendees to fill up at least a portion of the no-show seats. The systems and methods may increase attendance of an event, which leads to an increased revenue from the event by opening up a new revenue stream with no-show tickets and unsold seat inventory, and increasing concession and merchandise revenues.

Second, some embodiments described herein include event ticket distribution systems and methods that provide flexible tickets at discounted prices, thereby discovering new audiences, such as customers who cannot afford, or are unwilling to, pay full price on a ticket, customers who decide last minute to attend an event, customers who have attended or expressed interest in past events, and other niche groups such as students, community organizers, etc.

Third, some embodiments described herein include event ticket distribution systems and methods that may improve user experiences with events by real-time interaction with current and potential customers, such as regular ticket holders, flexible ticket holders, and potential ticket buyers. For example, seats for regular tickets or flexible tickets may be upgraded based on a real-time scan data indicating which regular tickets have not been scanned by a predetermined time (e.g., 5 minutes after an event starts). In addition or alternatively, seat upgrades may be provided based on prediction of which regular ticket holders will not show up. Further, seats for flexible ticket holders may be effectively reassigned or upgraded as the ticket scan status is updated in real-time, thereby providing customers an opportunity to fill vacant seats in better areas, which will result in improved user experience and satisfaction.

Fourth, some embodiments described herein include event ticket distribution systems and methods that proactively interact with ticket holders and identify tickets that will be unused. The systems and methods can operate to permit the ticket holders to return unused tickets and increase a chance to resell the unused tickets ahead of time, thereby increasing attendance rate and revenue.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a block diagram that illustrates an example system for managing allocation or distribution of electronic tickets.

FIG. 2 is an example timeline for managing ticket allocation or distribution to facilitate reduction of no-shows at an event.

FIG. 3 illustrates an example model for predicting a number of no-shows for an event.

FIG. 4 is a flowchart of an example method for implementing flexible tickets.

FIG. 5 illustrates example seat assignment schemes for flexible tickets.

FIG. 6 illustrates an example notification that is delivered to a computing device.

FIG. 7 is a flowchart of an example method for identifying empty seats or no-shows using a proactive communication.

FIG. 8 illustrates an example user interface for an application that displays a dashboard page.

FIG. 9 illustrates an example user interface for the application that displays a flexible ticket management page.

FIG. 10 illustrates an example user interface of the application that displays a proactive no-show management page.

FIG. 11 illustrates an example user interface of the application that displays a ticket sales page.

FIG. 12 illustrates an example user interface of the application that displays example information about event and ticket inventory.

FIG. 13 illustrates an example user interface of the application that displays an example overview of the event results for each event.

FIG. 14 illustrates an example user interface of the application that displays an example scan report.

FIG. 15 illustrates an example user interface of the application that provides an example dashboard page.

FIG. 16 is a block diagram of computing devices that may be used to implement the systems and methods described in this document, as either a client or as a server or plurality of servers

### DETAILED DESCRIPTION OF ILLUSTRATIVE EMBODIMENTS

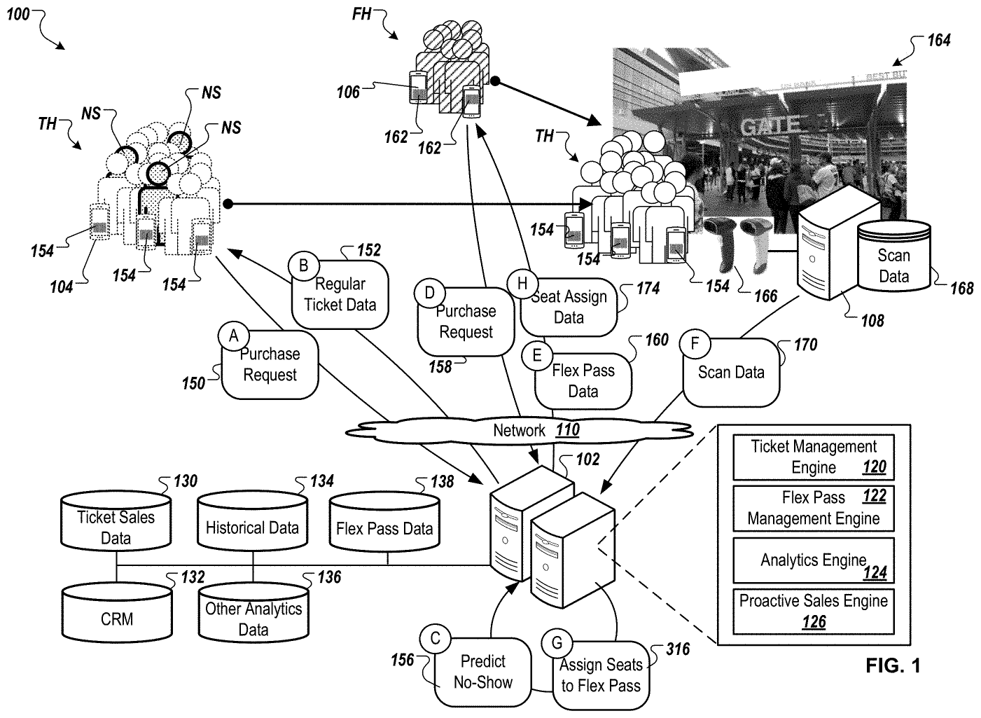

Referring to FIG. 1, an example system 100 is illustrated that can manage allocation or distribution of electronic event tickets. The system 100 can include a ticket management server 102, a plurality of regular ticket holder computing devices 104, one or more flexible ticket holder computing devices 106, and a ticket scan server 108. The servers and devices in the system 100 can communicate via one or more data communication network 110.

The example system 100 manages allocation or distribution of electronic tickets. The system 100 can use flexibility and convenience in purchasing, canceling, transferring, exchanging, and other management of electronic tickets (e.g., mobile tickets) and online payment schemes to facilitate allocation or distribution of tickets. The system 100 can be configured to estimate or predict a number of no-shows and/or the likelihood of no-show for one or more particular seats, and distribute (e.g., allocate, assign, sell, etc.) flexible tickets (e.g., flex passes) to reduce empty seats resulting from the no-shows at events. Although it is primarily described herein that tickets are to be sold and purchased, it is understood that other forms of distributing and obtaining tickets are possible, such as distributing complementary tickets, claiming free tickets, redeeming gift tickets, etc.

The ticket management server 102 manages electronic tickets, such as original event tickets and flexible tickets. Flexible tickets are also referred to herein as flex passes, flexible event tickets, alternative tickets, or the like. The ticket management server 102 can further manage customer data in the context of ticket management. In some examples, the ticket management server 102 includes a ticket management engine 120, a flexible ticket management engine 122, an analytics engine 124, and a proactive sales engine 126. The ticket management server 102 may be any of a variety of appropriate computer systems, such as a remote cloud- based server system, a store-based computer system, and/or any combinations thereof. The ticket management server 102 may be configured as a single computer system or a plurality of computer systems that are connected via one or more networks. For example, the engines, such as the ticket management engine 120, the flexible ticket management engine 122, the analytics engine 124, and the proactive sales engine 126, may be implemented in a single computer system in one embodiment, or implemented in a plurality of computer systems, respectively, in another embodiment.

The ticket management engine 120 is configured to provide a tool for a user to distribute (e.g., allocate, assign, sell, etc.) electronic tickets for events, and monitor the ticket distribution. Optionally, the ticket management engine 120 can permit a user to analyze the distribution of regular tickets, and evaluate ticket pricing, revenue/profit, and other various aspects associated with the regular ticket distribution and event in general. Optionally, the ticket management engine 120 may further be configured to enable a user to control over promotion, marketing, and attendee management with respect to regular tickets.

The flexible ticket management engine 122 can be configured as a flexible ticket system for distributing flexible tickets. In some embodiments, the flexible ticket management engine 122 is configured as a separate system from the ticket management engine 120. The flexible ticket management engine 122 is configured to estimate or predict a number of no-shows in advance of the event, and determine a number of flexible tickets to be distributed in addition to the regular ticket sale. In addition or alternatively, the flexible ticket management engine 122 can predict a chance of no-show for a particular seat that has been sold. The flexible ticket management engine 122 can provide a tool for a user to distribute (e.g., allocate, assign, sell, etc.) flexible tickets, and communicate with potential customers for promotion and management of flexible tickets. The flexible ticket management engine 122 can assign seats to flexible tickets, and/or reassign seats to the flexible tickets, based in part on ticket scan data indicative of no- show status at the event.

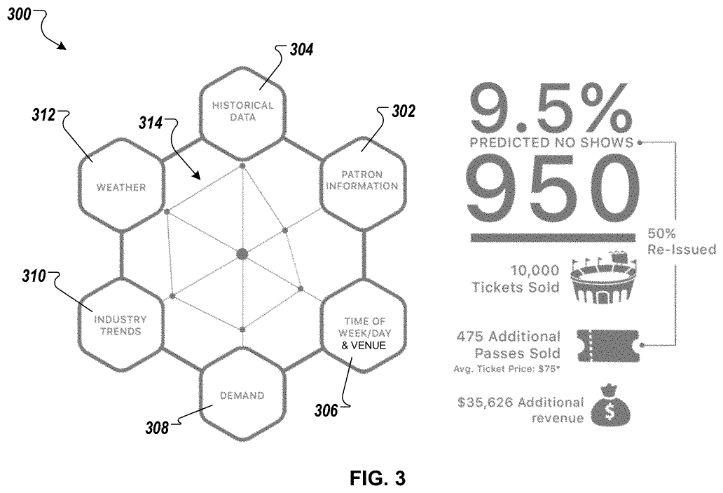

The analytics engine 124 is configured to predict a number of no-shows for an event, and/or a likelihood of no-show for particular seats, based on various factors. Examples of such factors are described herein, for example with reference to FIG. 3.

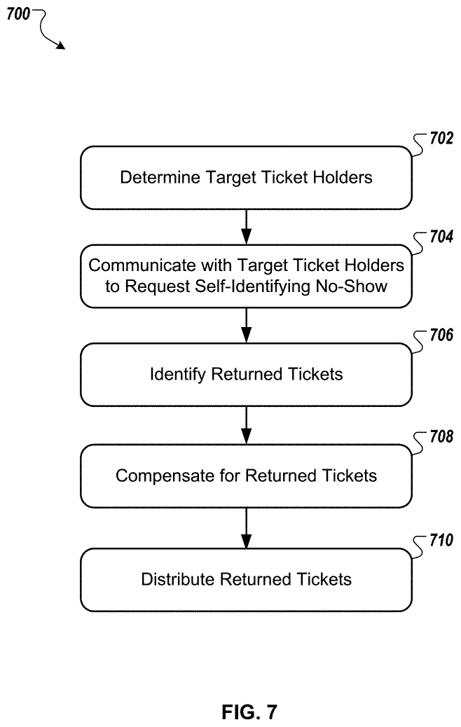

The proactive sales engine 126 is configured to implement a proactive measure for acquiring self-identifying no-show inventory. For example, the proactive sales engine 126 operates to communicate with and identify ticket holders who will not attend an event or will have a ticket go unused. An example operation of the proactive sales engine 126 is described herein, for example with reference to FIG. 7.

The ticket management server 102 may include or connect to one or more databases for various data, such as a regular ticket sales data 130, a customer data 132, a historical data 134, analytics data 136, and a flexible ticket data 138. The regular ticket sales data 130 may include information of ticket distribution status that is collected before and/or after an event. The regular ticket sales data 130 may include the number of regular tickets available, the number of regular tickets distributed, classification of regular tickets (e.g., seat types, prices, seat locations, transaction types, etc.), the number/percentage of no-shows, and other relevant information. The customer data 132 include information about ticket holders or purchasers and/or potential customers. The customer data 132 may be obtained from various sources such as user-created accounts, payment data, and other reliable sources. The historical data 134 may include historical information relating to past events, such as historical scan data, historical sales data, historical no-shows rate or average attendance per event type, seat location, etc. The analytics data 136 may include various data usable to predict no-shows for an event. Examples of such data include time of the event (e.g., time, week, day, etc.), demand, industry trends, weather, and other relevant information. The flexible ticket data 138 may include information about flexible tickets, such as the number of flexible tickets available, the number of flexible tickets distributed, classification of flexible tickets (e.g., different tiers of flexible tickets), seat assignments, and other relevant information.

Referring still to FIG. 1, an example operation of the ticket management server 102 is further described. Although the ticket management server 102 is primarily described to perform all operations, such as Steps A-G, in FIG. 1, it is understood that the ticket management server 102 may be configured as a plurality of computer systems that are connected via one or more networks. Further, at least one of the ticket management engine 120, the flexible ticket management engine 122, the analytics engine 124, and the proactive sales engine 126 can be implemented in a separate system. For example, the flexible ticket management engine 122 that is configured to manage and distribute flexible tickets is implemented in a flexible ticket system which is separate from a primary ticket system that may implement the ticket management engine 120.

The ticket management server 102 can receive purchase requests 150 from customers using their computing devices 104 (Step A). For example, regular tickets for an event may be offered for distribution (e.g., sale) on various platforms, such as online platforms (e.g., ticketing websites and social media sites) and offline platform (e.g., box offices or ticket offices). In some embodiments, the customers can access online platforms and submit the requests for purchasing the tickets using their computing devices 104. The purchase requests 150 can be transmitted from the customers' computing devices 104 to the ticket management server 102 via the networks 110. The purchase requests 150 may include various information about tickets to be purchased or reserved for an event, such as seats, seat sections, event description (e.g., dates/times, venues, etc.), prices offered and/or accepted, payment information, etc.

The ticket management server 102 can process the purchase requests 150 and provide regular ticket data 152 to the customers who submitted the purchase requests 150 (Step B). In response to a purchase request, the ticket management server 102 can provide a link to an electronic ticket (e.g., included in a text message, email, etc.) to the customer's computing device. When the link is selected by a customer on the customer's computing device, the ticket management server 102 can transmit the regular ticket data 152 to the customer's computing device, so that the customer's computing device can display information (in the form of electronic ticket 154) relevant to the purchased ticket. The regular ticket data 152 may include information that confirms purchase of the tickets, and other ticket information that the customers need to check in the event, such as seat information, event description, and/or customer information. The regular ticket data 152 may be stored in the ticket management server 102. Alternatively or in addition, the regular ticket data 152 may be stored in customers' computing devices and used to generate electronic tickets 154 on the customers' computing devices 104. The electronic tickets 154 may include an optical, machine-readable representation of tickets, such as barcodes (linear barcodes or matrix barcodes), on the customers' computing devices 104.

In Steps A and B, customers can purchase or otherwise obtain original electronic tickets 154 that are up for distribution (e.g., allocation, assignment, sale, or other forms of distribution) at predetermined prices (e.g., regular prices). The customers who purchased or otherwise obtained regular tickets 154 can present the tickets 154 using their computing devices 104. In this document, the customers who obtained tickets at regular prices are referred to as regular ticket holders or customers TH, and their computing devices 104 are referred to as regular ticket holder computing devices 104.

The ticket management server 102 can obtain distribution status of regular tickets 154. The regular ticket distribution status may indicate the number of regular tickets that have been distributed as of a predetermined date prior to the event. In addition or alternatively, the regular ticket distribution status may identify the regular tickets that have been distributed, and/or the regular tickets that are still available for distribution as of a particular date. In addition or alternatively, the regular ticket distribution status may include information of the regular ticket holders. In some embodiments, the regular ticket distribution status may be obtained from, and/or stored as, the regular ticket sales data 130. The ticket management server 102 can operate to generate distribution status by analyzing the purchase data 150 and/or the regular ticket data 152. Alternatively or in addition, the distribution status can be created by one or more remote computing devices and transmitted to the ticket management server 102.

When the regular ticket distribution data (e.g., the regular ticket sales data 130) are obtained, the ticket management server 102 can predict one or more no-shows among the regular tickets 154 that have been distributed (Step C). The server 102 can estimate or predict a number of no-shows from the distributed regular tickets 154. In addition or alternatively, the server 102 can identify one or more particular regular tickets 154 that are likely to become no-shows. The server 102 can generate no-shows data 156 based on the estimate and/or prediction in Step C.

Various algorithms may be used to estimate or predict no-shows among the distributed regular tickets 154. In some embodiments, historical data relating to the subject event or similar events, such as historical ticket sales, historical ticket scans, historical attendance and/or no-show rates, may be used to estimate a number of no-shows at the subject event. In other embodiments, more sophisticating predictive analytics may be used to predict the number of no-shows at the event. Such predictive analytics may use not only historical data but other suitable data such as ticket types (e.g., corporate seating, season ticketholder, etc.), customer information, date/time of the event, venue of the event, ticket demand, industry trends, weather, and other relevant information.

In some embodiments, no-shows can be estimated or predicted for the entire seats for an event in general. By way of example, where 10,000 regular tickets are sold, 950 no-shows can be predicted among the entire 10,000 regular tickets. In addition or alternatively, no-shows can be estimated or predicted for each of different sections or categories of regular tickets for an event. By way of example, where 2,000 regular tickets for a lower seat section, 4,000 regular tickets for a middle seat section, and 4,000 regular tickets for an upper seat section are sold, no-shows can be predicted for each of the regular tickets for different seat sections, such as 200 no-shows from the lower seat section, 500 no-shows from the middle seat section, and 250 no-shows from the upper seat section.

In Step C, the server 102 can further determine a number of flexible tickets to be offered for distribution. In some embodiments, the number of flexible tickets may be selected as a predetermined portion (e.g., 50%) of the number of no-shows. In other embodiments, the number of flexible tickets may be determined to be identical to or greater than the number of no-shows. In some embodiments, the number of flexible tickets is fixed and does change over time once the number of flexible tickets have been determined. In other embodiments, additional flexible tickets may be created and offered for distribution over time, or some of the flexible tickets that have been created may be removed from distribution over time, depending on the regular ticket distribution status.

Similarly to the regular tickets, flexible tickets may be offered for distribution (e.g., sale) on various platform, such as online platforms (e.g., ticketing websites and social media sites) and offline platform (e.g., box offices or ticket offices). Customers can access online platforms and submit purchase requests 158 for obtaining flexible tickets using their computing devices 106 (Step D). The purchase requests 158 may be transmitted from the customers' computing devices 106 to the ticket management server 102 via the networks 110. The purchase requests 158 may include various information about flexible tickets to be purchased or reserved for an event, such as seat sections, event description (e.g., dates/times, venues, etc.), prices offered and/or accepted, payment information, etc.

The ticket management server 102 can process the purchase requests 158 and provide flexible ticket data 160 to the customers who submitted the purchase requests 158 (Step E). In response to a purchase request, the ticket management server 102 can provide a link to an electronic ticket (e.g., included in a text message, email, etc.) to the customer's computing device. When the link is selected on the customer's computing device, the ticket management server 102 can transmit the flexible ticket data 160 to the customer's computing device, so that the customer's computing device can display information (in the form of electronic ticket 162) relevant to the purchased flexible ticket. The flexible ticket data 160 may include information that confirms purchase of the flexible tickets, and other ticket information that the customers need to check in the event, such as event description and/or customer information. The flexible ticket data 160 may be stored in the ticket management server 102. Alternatively or in addition, the flexible ticket data 160 may be stored in customers' computing devices and used to generate electronic flexible tickets 162 on the customers' computing devices 106. The electronic ticket 162 may include an optical, machine-readable representation of tickets, such as barcodes (linear barcodes or matrix barcodes), on the customers' computing devices 106.

Unlike regular tickets 154, flexible tickets 162 are designed to fill in at least a portion of the no-shows that have been estimated or predicted prior to the event. In some embodiments, flexible tickets 162 do not have assignments to particular seats until a particular time relative to the event, such as shortly before or shortly after the event begins. Flexible tickets 162 may be assigned to seats when no-shows of such seats are confirmed. For example, flexible tickets 162 are assigned to seats when it is determined that the regular tickets for those seats have not been scanned until the event starts, or by a particular time before or after the event starts.

In addition or alternatively, flexible tickets 162 may be assigned to seat sections or categories although particular seats are not assigned at the time of purchase. By way of example, where there are three different seat sections available at an event, such as lower, middle, and upper seat sections, each of flexible tickets 162 are assigned to one of the different seat sections, and will be assigned to a seat in the assigned one of the different seat sections later, unless a seat upgrade is provided complimentarily or at purchase.

In some embodiments, flexible tickets 162 may be offered for sale at lower prices than regular tickets 154. For example, flexible tickets 162 are distributed as secondary to regular tickets 154 with less benefits than the regular tickets 154, such as no-confirmed seat assignments, last-minute seat assignments, or chance of seat reassignments at the event. Thus, flexible tickets 162 may be offered at discounted prices to attract other customers who were not able to purchase regular tickets because they were sold out, who cannot afford or are unwilling to pay full prices on tickets, who decide last minute to attend an event, or who are otherwise interested in purchasing tickets at lower prices.

In Steps D and E, customers can purchase or otherwise obtain alternative electronic tickets 162 that are up for distribution (e.g., allocation, assignment, sale, or other forms of distribution). The customers who purchased or otherwise obtained flexible tickets 162 can present the tickets 162 using their computing devices 106. In this document, the customers who obtained flexible tickets 162 are referred to as flexible ticket holders or customers FH, and their computing devices 106 are referred to as flexible ticket holder computing devices 106.

As the time for the event approaches, the regular ticket holders TH come to a venue 164 of the event and begin checking in with the regular tickets 154. In some embodiments, a ticket scan server 108 may be provided to monitor tickets being scanned in at the venue 164. For example, ticket scanners 166, such as handheld scanners, kiosks, and other suitable ticket scanning devices, may be provided to scan the regular tickets 154 of the ticket holders TH who show up at the venue. In other examples, the ticket scanners 166 may be provided as an application running on ticket holders' computing devices and configured to permit online check-in by the ticket holders. The data of the regular tickets 154 that have been scanned using the ticket scanner 166 may be transmitted to the ticket scan server 108, and can be stored in a database 168 associated with the ticket scan server 108. The data of the scanned regular tickets 154 can be stored as scan data 170 in the database 168.

The ticket management server 102 can receive the scan data 170 from the ticket scan server 108 (Step F). The scan data 170 include check-in status of the regular tickets 154, such as which regular tickets 154 have been scanned or have not been scanned over time. The scan data 170 may be used to identify seats that have not been occupied due to no-shows over time.

The ticket management server 102 can assign seats to one or more of the flexible tickets 162 based on availability of such seats identified from the scan data 170 (Step G). The seat assignments for flexible tickets 162 can be automatically performed by the ticket management server 102. In addition or alternatively, a user may use a tool provided by the ticket management server 102 and manually assign seats to flexible tickets 162 based on the scan data 170 that indicate availability of the seats at the event.

One or more criteria may be predetermined and applied in assigning available seats to flexible tickets 162. In one example, inferior seats (e.g., seats at lower prices or seats with restricted views) may be first assigned to flexible tickets 162 with upgrading options or possibilities. When better seats remain available until later or become available later, the flexible tickets 162 having the inferior seats assigned may be reassigned to the better seats with or without additional costs.

The ticket management server 102 can transmit seat assignment data 174 to one or more flexible ticket holder computing devices 106 (Step H). The seat assignment data 174 can be created at Step G in which available seats are identified based on the scan data 170 and assigned to flexible tickets 162. The seat assignment data 174 indicate seat assignment to flexible tickets 162. The seats assigned to flexible tickets 162 may be selected from seats originally assigned for one or more of the regular tickets 152 that have been determined as no-shows based on, for example, the scan data 170. In addition or alternatively, the seats assigned to flexible tickets 162 may be selected from seats that have not been sold or occupied for regular tickets or flexible tickets.

The seat assignment data 174 may be transmitted to flexible ticket holder computing devices 106 via the network 110. In some implementations, the seat assignment data 174 may be transmitted to flexible ticket holder computing devices 106 via text messages which are fast and reliable during a network congestion. In other implementations, other forms of data communication can be used to transmit the seat assignment data 174 using emails, mobile applications, push notifications, voice messages, and any other suitable formats.

Such seat assignment may occur at various stages of time. For example, seat assignments for flexible tickets may start when the scan data indicate a predetermined number of regular tickets, or a predetermined percentage of regular tickets over the number of regular tickets sold, have been scanned. Alternatively, seat assignments may start at a particular time prior to or after the event begins, or at the time the event begins. Other implementations are also possible.

In some implementations, at least part of the ticket management system 102 described herein can be used to upgrade particular types of regular tickets (e.g., VIPs, loyal fans, and season ticket holders). If the ticket management system 102 identifies (e.g., predicts, or determining with ticket scan data) no-shows, the ticket management system 102 can upgrade a small segment of such tickets to better seats that are identified as no-shows. Such upgrade may be offered free of charge (or minimal price) to build loyalty with fans or other marketing purposes. In some embodiments, the ticket management system 102 can be configured to perform this type of upgrade without distributing any flexible ticket as described herein. In other embodiments, the ticket management system 102 can perform this upgrade along with distributing and managing flexible tickets as described herein.

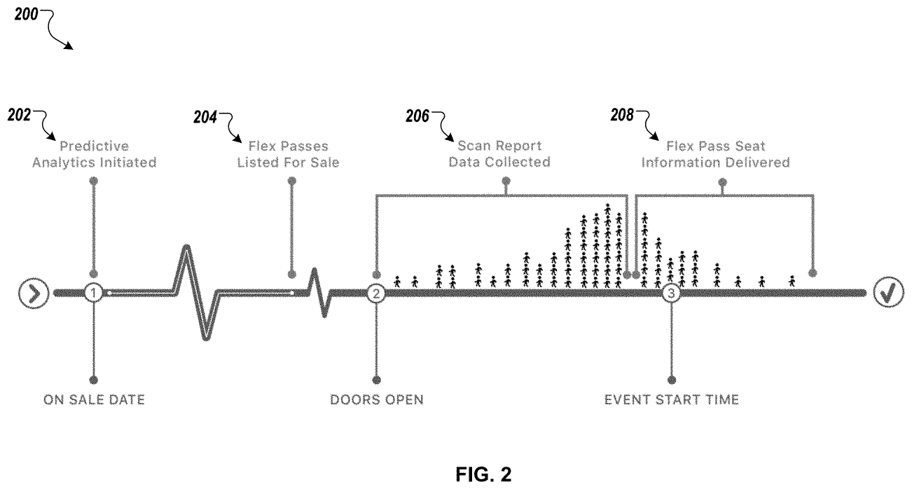

FIG. 2 is an example timeline 200 for managing ticket distribution to facilitate reduction of no-shows at an event. In some embodiments, the timeline 200 may represent at least part of the operation of the system 100 of FIG. 1. For example, when regular tickets are offered for sale from a predetermined ticket sale date, the system 100 can obtain sales status of regular tickets. The system 100 can further estimate or predict a number of no-shows among the regular tickets that have been sold (Step 202). The number of no-shows may be calculated as a rate of no-shows over the regular tickets sold, or over the number of entire seats available. Step 202 may be performed similarly to Step C of FIG. 1.

In some embodiments, the number of no-shows may be determined based on the number of regular tickets sold and/or historical data, such as historical average of no-shows for a past event of the same performance (e.g., a past concert of the same musician) or a past event of the same or similar type. In addition, predictive analytics using one or more statistical analysis models may be used to predict a number of no-shows among the regular tickets. Such predictive analytics may take into account event-related data that indicate one or more factors. Such factors include historical data relating to the subject event or similar events (e.g., historical ticket sales, historical ticket scans, and historical no-show rates), expected weather, sales figures (which may be obtained from the sale status of regular tickets), ticket types (e.g., season tickets, corporate seats, complimentary tickets, etc.), patron information, event time, event data, event venue, ticket demand, industry trends, and any other information usable to predict the number of no-shows.

Once the number of no-shows are calculated, the system 100 can list a number of flexible tickets (e.g., flex passes) for sale (Step 204). Step 204 may include at least part of Steps C, D, and E of FIG. 1. The number of flexible tickets may be determined based on the number of no-shows. In some embodiments, a conservative approach may be applied to select the number of flexible tickets smaller than the number of no-shows. In other embodiments, more aggressive approaches permit flexible tickets to be generated close to (but smaller than) the number of no-shows, or substantially equal to or more than the number of no-shows.

Flexible tickets may be offered for sale at various stages of time before the event starts. The timing of distribution of flexible tickets may depend at least on the sales status of regular tickets and/or ticket demands. By way of example, if the tickets are in demand and will likely be sold out, flexible tickets may be listed for sale earlier or even at the same time when the regular tickets are listed for sale. If the tickets will not likely to be sold out until close to the beginning of the event, or if the tickets will not likely be sold out at all, flexible tickets may be listed for sale closer to the beginning of the event.

When the door is open for the event and allows regular ticket holders to check in, the system 100 can collect scan report data, such as the scan data 170, which may indicate the scan status of regular tickets in real-time (Step 206). Step 206 may be performed similarly to Step 170 of FIG. 1. In some embodiments, the scan report data may indicate which regular tickets are scanned for check-in. As the regular tickets are associated with pre-assigned seats, the scan status of regular tickets may indicate which seats are occupied. The scan report data can be generated and collected in real-time as the regular tickets are scanned. In some embodiments, the scan report data may be collected and updated continuously or periodically while regular tickets are scanned. Such continuous or periodic collection and update of the scan report data may be considered as real-time collection of the scan report data.

In some embodiments, the door may remain open until a particular time after the event starts so that regular ticket holders and/or flexible ticket holders can check in by having their regular tickets or flexible tickets scanned. In other embodiments, the door is closed shortly before, as soon as, or shortly after the event starts.

While monitoring the scan report data, the system 100 can deliver seat information to one or more of the flexible tickets (Step 208). Step 208 may include Steps G and H of FIG. 1. With the status of available seats identified from the scan report data, one or more of the available seats are assigned to one or more of the flexible tickets, and such seat assignment information may be delivered to flexible ticket holders who possess the one or more of the flexible tickets. The seat assignment to flexible tickets may be performed manually by an operator using an application provided by the system 100, or automatically by the system 100. The delivery of seat assignment information may be electronically delivered to flexible ticket holders' computing devices, such as mobile devices. Seat assignment information may be transmitted using one or more of various formats, such as text messages, emails, push notifications, telephone calls, voice messages, etc.

The seat assignment and delivery for flexible tickets can start from various stages in the timeline 200, which may depend on various factors such as event type, ticket sales status, real-time ticket scan status, etc. For example, the seat assignment and delivery can begin at a predetermined time (e.g., 10 minutes) before the event starts. In other examples, the seat assignment and delivery can begin at the time or after the event starts. Similarly, the seat assignment and delivery can end at various stages in the timeline 200, which may depend on various factors, such as event type, ticket sales status, real-time ticket scan status, etc. For example, the seat assignment and delivery can end at a predetermined time (e.g., 30 minutes) after the event begins. In other examples, the seat assignment and delivery can end before or at the time the event starts. Other timings for starting and ending the seat assignment and delivery for flexible tickets may also possible.

FIG. 3 illustrates an example model 300 for predicting a number of no-shows for an event. The model 300 can use predictive analytics for analyzing various pieces of current and historical data using one or more statistical techniques to make predictions about event attendance (or no-show rate). The data that can be used for the predictive model 300 may include customer data or patron information 302, such as the customer data 132 (FIG. 1). The customer data 302 include customer name or identifier, account identifier, contact information, and other personal information.

In addition or alternatively, the data used for the predictive model 300 may include historical data 304, such as the historical data 134 (FIG. 1). The historical data 304 may include details about the event (such as teams, performers, plays, genres, etc.), which may be used to identify several factors such as frequently sparse seat sections, patron arrival times, a number of last minute ticket purchases, etc. The historical data 304 may further include historical ticket sales, historical ticket scan statuses, historical no-show rates, etc. for the same event, or for similar or comparable events in the past. The historical data 304 may further include historical no-shows for repeat customers.

In addition or alternatively, the predictive model 300 can use an event timing and venue 306, such as time of day, day of week, week, month, year of the event, and location of the event. By way of example, a start time of the event at a particular location (e.g., starting at 6 PM in a downtown area, which is typically a rush hour) may affect attendance rate and/or arrival time.

In addition or alternatively, the predictive model 300 can use ticket demand 308, industry trends 310, and/or weather information 312. The ticket demand 308 may represent popularity of the event and/or marketplace prices. The ticket demand 308 may include secondary marketplace demand and/or prices. The industry trends 310 are factors that are prevalent in the ticketing industry that may affect attendance patterns. The weather information 312 indicates a weather forecast around the time of the event. By way of example, a rainy day would more likely discourage attendance for an outdoor event than a sunny day.

In addition or alternatively, other factors may be used by the predictive model 300, such as ticket types (e.g., season tickets, corporate seats, complimentary tickets, etc.), current ticket sales figures, customer origin location (e.g., determined based on, e.g., home address in CRM system), current customer location (detected by, e.g., a device GPS), event and performer social media mentions, event promotion (e.g., bubblehead night), conflicting events (e.g., another event like Super Bowl on the same date/time as the subject event), competitor pricing, and other suitable information.

In some embodiments, as indicated with reference number 314, one or more of the factors, such as data 302, 304, 306, 308, 310, and 312, may be weighted differently to provide accurate prediction of no-show rates.

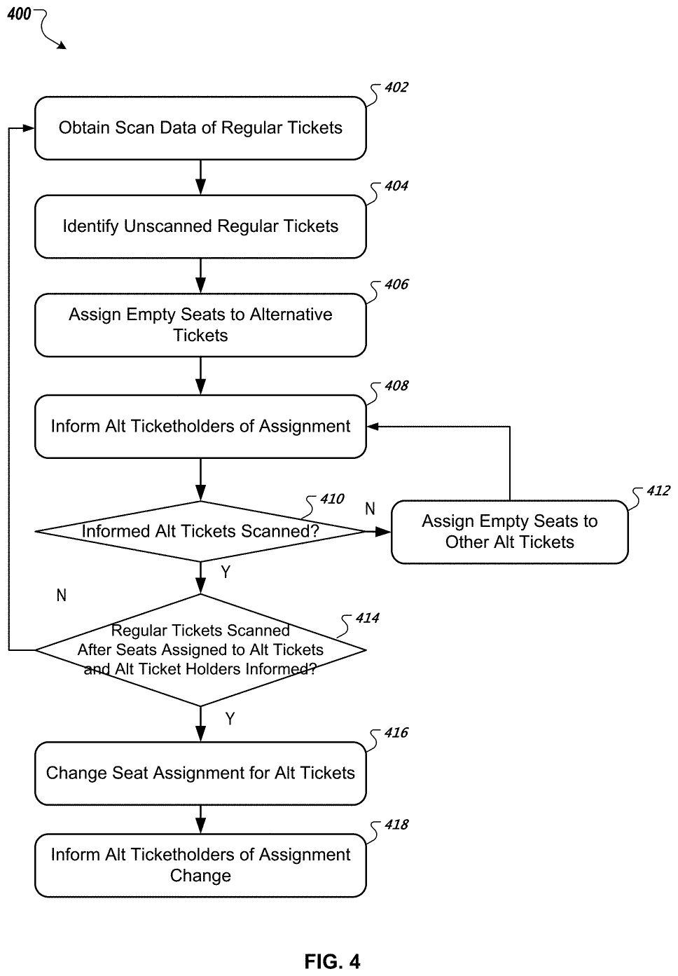

FIG. 4 is a flowchart of an example method 400 for implementing flexible tickets, such as assigning seats to flexible tickets and delivering seat assignments to flexible ticket holders. At least part of the method 400 can be used to perform Steps G and H (FIG. 1) or Step 208 (FIG. 2). The method 400 is primarily illustrated herein to be performed at least by the ticket management server 102. However, other computing devices can be used to perform at least part of the method 400 in other implementations.

The method 400 may include operation 402 of obtaining scan data of regular tickets. In some embodiments, the scan data, such as the scan data 170, can be collected in real time as the regular ticket holders TH show up at the venue 164 and scan their regular tickets to check in. The method 400 may include operation 404 of identifying regular tickets that have not been scanned by the time the event starts, or by a particular time before or after the event starts. Such unscanned regular tickets can be identified from the scan data, and used to identify seats that have not been occupied. The method 400 may include operation 406 of assigning one or more of the empty seats to one or more of the flexible tickets. The method 400 may include operation 408 of informing flexible ticket holders of seat assignments. In some embodiments, the seat assignments may be electronically delivered to flexible ticket holders' computing devices, such as using text messages, emails, push notifications, telephone calls, and/or voice messages.

After seat assignments for flexible tickets are transmitted to flexible ticket holders, the flexible ticket holders can check in the event by having their flexible tickets scanned. The method 400 may include operation 410 of determining whether the informed flexible ticket holders have their flexible tickets scanned for check-in. The flexible ticket holders may be required to check in by scanning their flexible tickets by a predetermined time after the seat assignments are informed, or by a predetermined time relative to the start of the event. If it is not determined that the flexible tickets of the informed flexible ticket holders have been scanned (“NO”), the method 400 moves on to operation 412. If it is determined that the flexible tickets have been scanned (“YES”), the method 400 continues at operation 414.

The method 400 may include operation 412 of assigning to other flexible tickets the seats that had been assigned to the flexible tickets that end up not being scanned. Then, the method 400 returns to the operation 408 and its subsequent operations.

The method 400 may include operation 414 of determining whether regular ticket holders have their regular tickets scanned for particular seats after the particular seats have been assigned to flexible ticket holders (as in the operation 406) and such seat assignments have been informed to flexible ticket holders (as in the operation 408). If it is not determined that the regular tickets have been scanned afterwards (“NO”), the method 400 returns to the operation 402 and its subsequent operations. If it is determined that the regular tickets have been scanned afterwards (“YES”), the method 400 moves on to operation 416.

The method 400 may include operation 416 of changing seat assignments for the flexible tickets. As the regular tickets for the seats are now scanned after the same seats have been assigned to the flexible tickets, the flexible tickets need to yield the seats to the regular ticket holders, and should have other empty seats reassigned. The operation 416 may include identifying other empty seats and reassign those seats to the flexible tickets so that the seats initially assigned to the flexible tickets are now taken by the regular ticket holders who have just checked in.

The method 400 may include operation 418 of informing the flexible ticket holders of change in seat assignments. In some embodiments, the seat reassignments may be electronically delivered to flexible ticket holders' computing devices, such as using text messages, emails, push notifications, telephone calls, and/or voice messages.

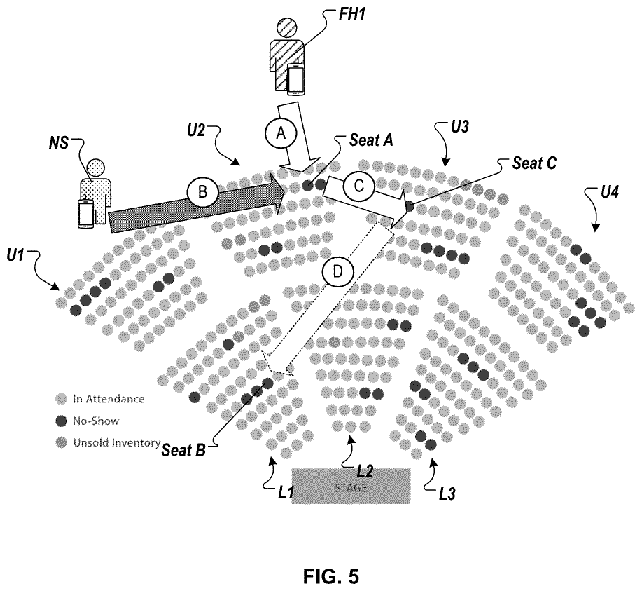

FIG. 5 illustrates example seat assignment schemes 500 for flexible tickets. As described herein, some embodiments of flexible tickets are sold without seat assignments and later assigned to seats as the seats become available because regular tickets for the seats have not been scanned by a particular time, or because the seats have not been sold by the particular time. Flexible tickets that have been assigned to particular seats may be reassigned to different seats as necessary. For example, if the ticket scan data indicate that the regular tickets for the particular seats has just been scanned, the flexible tickets should be reassigned to different empty seats to make the particular seats available for the regular ticket holders. Flexible tickets may be reassigned multiple times as the ticket scan data is updated in real-time.

In addition or alternatively, a flexible ticket for an inferior seat can be upgraded to a better seat if the regular ticket for the better seat has not been scanned until a predetermined time (e.g., 5 minutes before the event begins). The flexible ticket that has been updated may be reassigned or downgraded to a different seat as the ticket scan data is updated in real-time.

In the illustrated example of FIG. 5, a first flexible ticket holder FT1 has purchased a flexible ticket for upper seat sections U (including U1, U2, U3, and U4) that is cheaper than lower seat sections L (including L1, L2, and L3). Then, the flexible ticket was first assigned to seat A in a second upper seat section U2 as the seat A is determined to be no-show. However, it is now determined that a regular ticket holder NS who was initially identified as no-show has just checked in for seat A. Then, the flexible ticket for the first flexible ticket holder FT1 can be reassigned to a different seat in one of the originally purchased seat sections (e.g., one of the upper seat sections U).

In some optional implementations, the first flexible ticket holder FT1 may be given an opportunity for upgrade to seat B in a first lower seat section L1 as seat B has been determined to be no-show. The ticket management system 102 can be configured to increase or maximize a number of flexible tickets that are eventually upgraded to better seats than the ones they have originally been assigned or reassigned.

In addition or alternatively, the ticket management system 102 is configured to determine better seats among the seats that have been identified as no-show, and assign or reassign (not necessarily by upgrade) them to the flexible tickets so that better seats end up being occupied and inferior seats (if any) are left unoccupied eventually.

In addition or alternatively, flexible tickets that have been assigned to particular no-show seats in a particular section may be reassigned to a different seat in the same section or in a different section (which may be the same level as, or an upgraded or downgraded level from, that particular section).

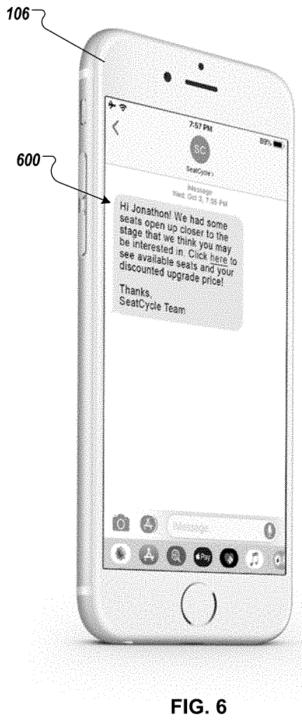

FIG. 6 illustrates an example notification 600 that is delivered to a ticket holder computing device. In the illustrated example, the notification 600 is delivered as a text message to the flexible ticket holder computing device 106 and/or the regular ticket holder computing device 104. The notification 600 may contain one or more of various pieces of information described herein, such as seat assignment, seat reassignment, upgrade opportunity, etc. In the illustrated example, the text message is composed to suggest an opportunity for seat upgrade.

FIG. 7 is a flowchart of an example method 700 for identifying empty seats or no-shows using a proactive communication. In general, the method 700 may use a targeted communication to identify original ticket holders who will not attend an event or will have a ticket go unused, thereby acquiring self-identifying no-show inventory. The method 700 may include operations of directly reaching regular ticket holders to gauge which and how many seats will go unfilled, and reselling the returned tickets to provide new customers with opportunity to attend the event. The regular ticket holders may be compensated if their tickets are returned and resold. Alternatively or in addition, the regular ticket holders may be compensated for responding with their attendance status and/or returning tickets. The compensation can be of various forms, such as cash rewards, reward points, coupons, gift certificates, and other suitable compensation methods. The compensation may include a waiver of any agreed fee (e.g., cancellation fee) upon returning the tickets. The method 700 may be primarily illustrated herein to be performed at least by the ticket management server 102. However, other computing devices may be used to perform at least part of the method 700 in other implementations.

The method 700 may include operation 702 of determining target regular ticket holders to contact. In some examples, various algorithms can be used to select one or more of the regular ticket holders. For example, historical data and/or customer information may be used to select regular ticket holders who are more likely to have tickets to return or go unused. In other examples, the regular ticket holders may be randomly selected. In yet other examples, all the regular ticket holders may be contacted.

The method 700 may include operation 704 of communicating with targeted regular ticket holders to request self-identifying one or more tickets that will be unused. In addition, the communication can include a request for returning or selling back the tickets that will be unused. The operation 704 may include delivering the communication via various forms, such as text messages, emails, voice messages, telephone calls, push notifications, etc.

The method 700 may include operation 706 of identifying returned tickets from the targeted regular ticket holders. The operation 706 may include receiving inputs from the target regular ticket holders to select one or more tickets to return or sell back. In some embodiments, the inputs can be entered via the target regular ticket holders' computing devices and transmitted to the ticket management server 102.

The method 700 may include operation 708 of compensating the targeted regular ticket holders for the returned tickets. The compensation can be of various forms, such as cash rewards, reward points, coupons, gift certificates, and other suitable compensation methods. The compensation may include a waiver of any agreed fee (e.g., cancellation fee) upon returning the tickets.

The method 700 may include operation 710 of distributing the returned tickets to other customers. In some embodiments, the returned tickets may be distributed as regular tickets at regular or discounted prices. In other embodiments, the returned tickets may be distributed as flexible tickets at discounted prices. In yet other embodiments, the returned tickets may be distributed at higher prices than the original prices, depending on the demands.

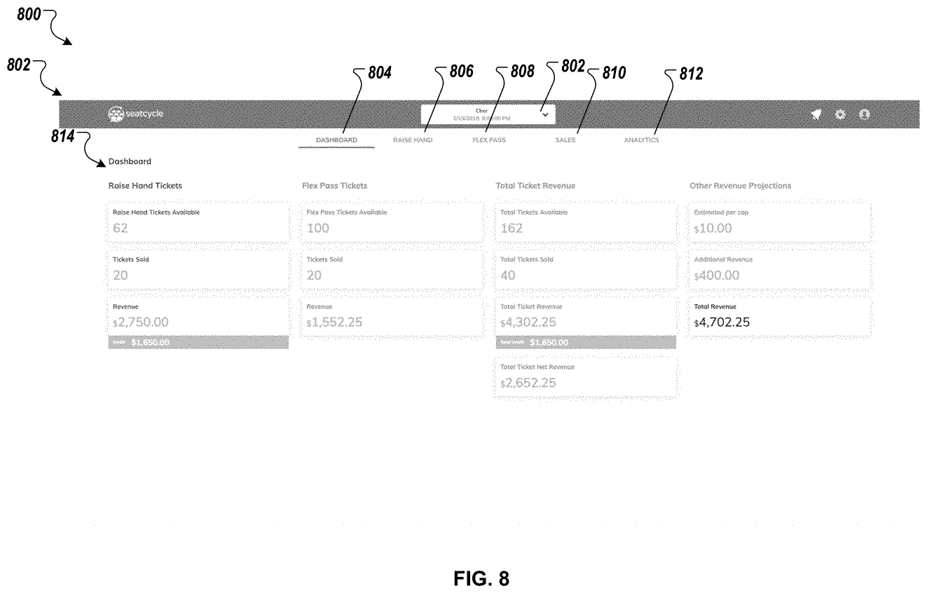

Referring to FIGS. 8-11, example user interfaces of an application 800 for managing distribution of event tickets are illustrated and described. The application 800 can be provided by the ticket management server 102 and configured to enable a user to manage distribution of flexible tickets. The user interfaces of the application 800 can display an event identifier 802 that identifies the event. The event identifier 802 may include, for example, the name of the event and the date/time of the event. The user interfaces of the application 800 may include one or more control elements for selecting different menus, such as dashboard 804, proactive no-show management (“Raise Hand”) 806, flexible ticket management (“Flex Pass”) 808, sales management 810, and analytics 812.

FIG. 8 illustrates an example user interface 802 for the application 800 that displays a dashboard page 814. The dashboard page 814 may be displayed upon selection of the dashboard control element 804. The dashboard page 814 shows a summary of various ticket distribution statuses, such as ticket status from the proactive no-show identification (“Raise Hand Tickets”), ticket status regarding flexible tickets (“Flex Pass Tickets”), total ticket revenue, and other revenue projections.

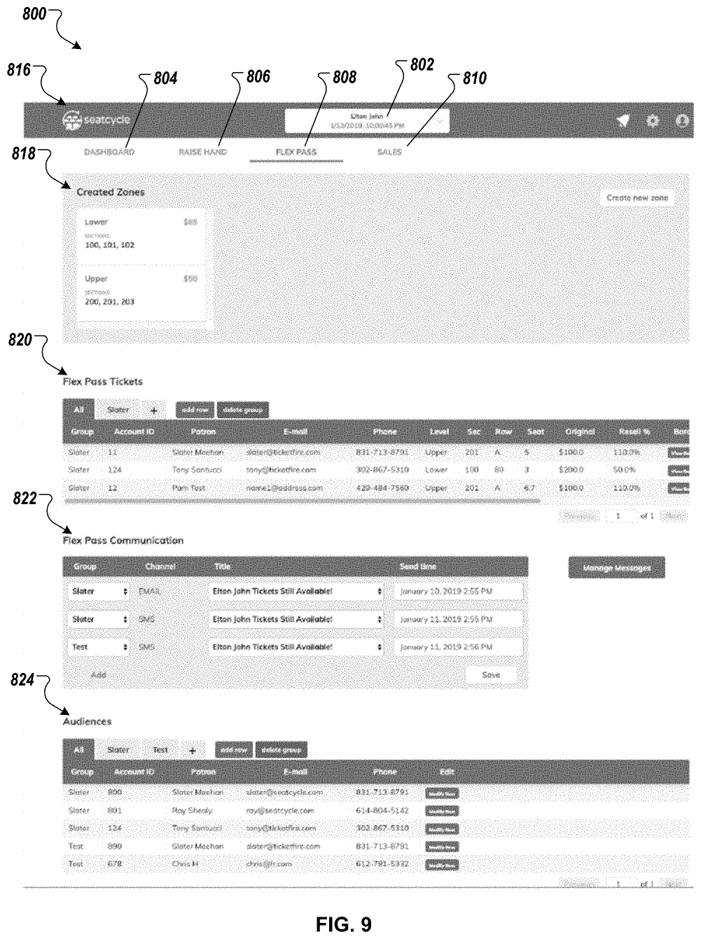

FIG. 9 illustrates an example user interface for the application 800 that displays a flexible ticket management page 816 upon selection of, for example, the control element 808. In some embodiments, the flexible ticket management page 816 can be configured to support and implement distribution of flexible tickets as described with reference to FIGS. 1-6. The flexible ticket management page 816 can include a seating zone management section 818, a flexible ticket sales status section 820, a flexible ticket communication section 822, and a customer listing section 824.

The seating zone management section 818 displays one or more seating zones (also referred to herein as levels, tiers, sections, categories, classifications, or the like) that are created for different tiers of flexible tickets. In the illustrated example, the seats are categorized into two zones, such as a lower zone having three sections (e.g., Sections 100, 101, and 102 in the lower zone) and an upper zone having three sections (e.g., Sections 200, 201, and 203 in the upper zone). Flexible tickets for different zones may be priced differently. In some embodiments, the seating zone management section 818 provides an interface that allows a user to create new zones and edit existing zones.

The flexible ticket sales status section 820 displays the sales status of flexible tickets. The flexible ticket sales status section 820 provides an interface to add new flexible ticket sale, and edit the existing list of flexible tickets that have been sold. Various pieces of information may be presented for the distributed flexible tickets. Examples of such information include account ID, customer name or identifier, contact information (e.g., email address, telephone number, etc.), seating information (e.g., level, section, row, seat number), original prices, resell percentage (e.g., a percentage of the original price for which the tickets are listed on marketplaces), credit percentage (e.g., a percentage of the original ticket price returned as credit, payment, etc. to the original ticket holder), payout (e.g., an amount of credit, payment, etc. returned to the original ticket holder), revenue (e.g. a total revenue from the resale of the ticket), and other desirable information.

The flexible ticket communication section 822 provides an interface to create and manage communications that will be delivered to customers. The flexible ticket communication section 822 enables a user to create messages and configure delivery options, such as communication channel (e.g., text message, email, etc.), title of message, time to send, etc. In addition or alternatively, the messages can be automatically created and/or delivered at desired times in desired manners.

The customer listing section 824 displays a list of customers, and/or provide an interface to add new customers and edit existing customers. The customer listing section 824 can show various pieces of information about each customer, such as account ID, customer name or identifier, contact information (e.g., email address, telephone number, etc.), and other desired information.

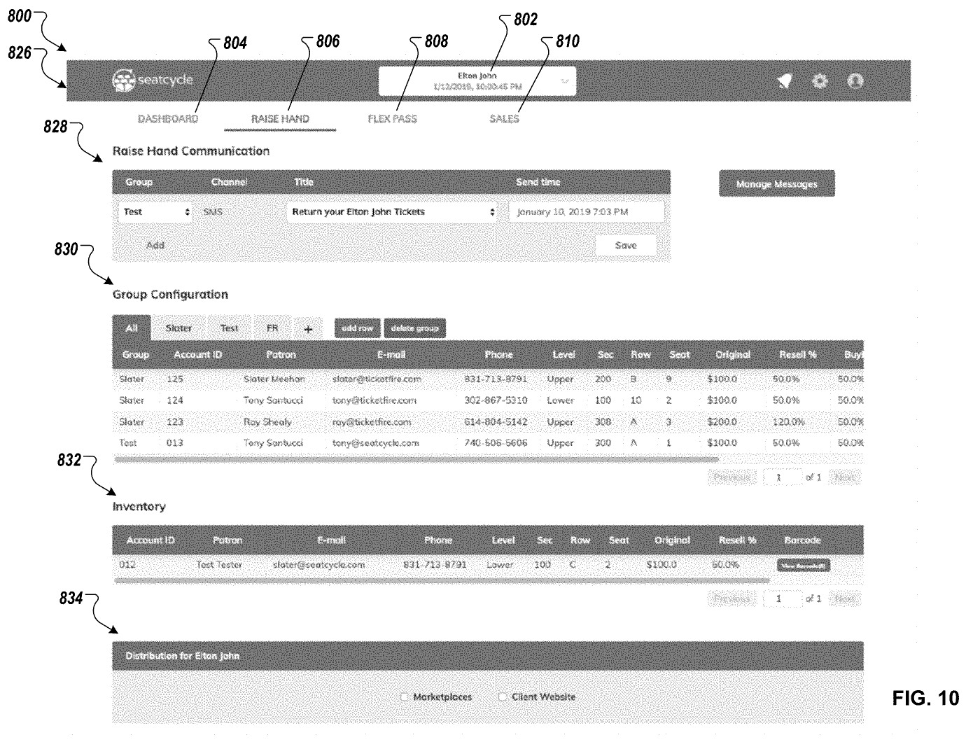

FIG. 10 illustrates an example user interface of the application 800 that displays a proactive no-show management page 826 upon selection of, for example, the control element 806. In some embodiments, the proactive no-show management page 826 can be configured to support and implement the method 700 of FIG. 7. The proactive no-show management page 826 may include a communication management section 828, a group configuration section 830, an inventory section 832, and a distribution method section 834.

The communication management section 828 provide an interface to create and manage communications that will be delivered to ticket holders. The communication management section 828 enables a user to create messages and configure delivery options, such as communication channel (e.g., text message, email, etc.), title of message, time to send, etc. In addition or alternatively, the messages can be automatically created and/or delivered at desired times in desired manners.

The group configuration section 830 displays a list of ticket holders who have purchased regular tickets. In a proactive no-show identification process (e.g., the method 700), at least one of the ticket holders from the list is selected and contacted to ask for self-identification of potential no-show tickets. The group configuration section 830 provides an interface to add new ticket holders possessing regular tickets, and edit the existing list of ticket holders. Various pieces of information may be presented for the ticket holders. Examples of such information include account ID, customer name or identifier, contact information (e.g., email address, telephone number, etc.), seating information (e.g., level, section, row, seat number), original prices, resell percentage (e.g., a percentage of the original price for which the tickets are listed on marketplaces), credit percentage (e.g., a percentage of the original ticket price returned as credit, payment, etc. to the original ticket holder), payout (e.g., an amount of credit, payment, etc. returned to the original ticket holder), revenue (e.g. a total revenue from the resale of the ticket) , and other desirable information.

The inventory section 832 displays a list of ticket holders who have identified that they would not attend an event or would have a ticket go unused. Various pieces of information may be presented in the inventory section 832. Examples of such information include account ID, customer name or identifier, contact information (e.g., email address, telephone number, etc.), seating information (e.g., level, section, row, seat number), original prices, resell percentage (e.g., a percentage of the original price for which the tickets are listed on marketplaces), credit percentage (e.g., a percentage of the original ticket price returned as credit, payment, etc. to the original ticket holder), payout (e.g., an amount of credit, payment, etc. returned to the original ticket holder), revenue (e.g. a total revenue from the resale of the ticket) , and other desirable information.

The distribution method section 834 provides an interface to identify and/or choose one or more methods for distributing the tickets returned from the regular ticket holders. In some embodiments, distribution methods may include distribution in marketplaces and distribution via client websites.

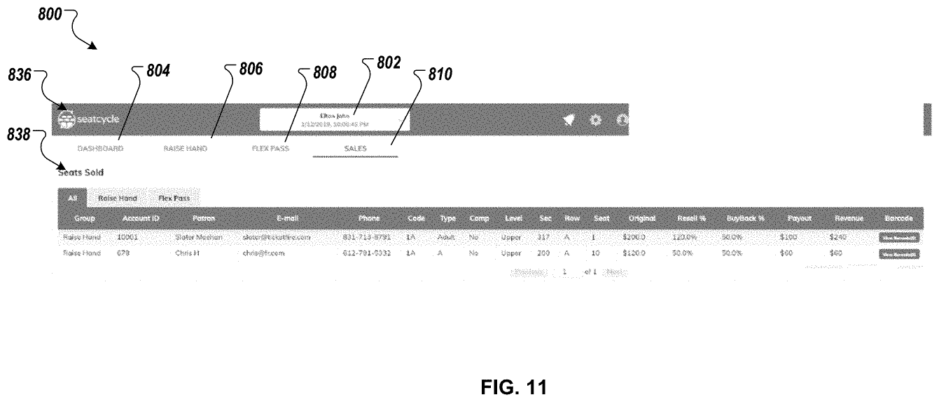

FIG. 11 illustrates an example user interface of the application 800 that displays a ticket sales page 836 upon selection of, for example, the control element 810. The ticket sales pages 836 can include a ticket sales list 838 that displays a list of tickets sold (or seats sold). Various pieces of information may be presented for the ticket sales list 383. Examples of such information include account ID, customer name or identifier, contact information (e.g., email address, telephone number, etc.), seating information (e.g., level, section, row, seat number), original prices, resell rate, buyback rate, payout price, revenue, and other desirable information.

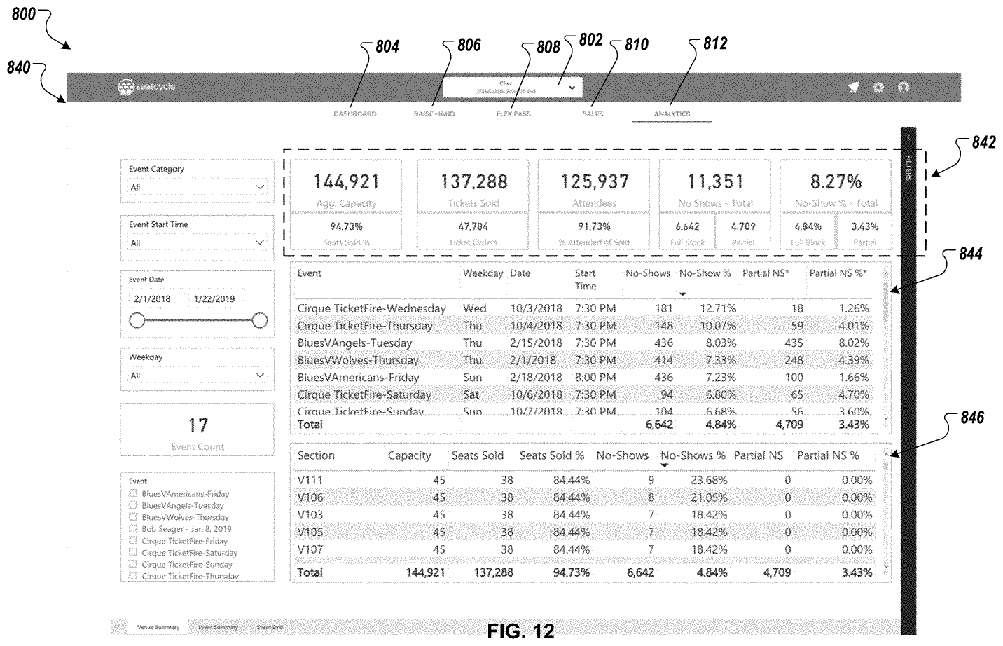

Referring to FIGS. 12-15, example user interfaces of an application 800 for managing distribution of event tickets with predictive analytics are illustrated and described.

FIG. 12 illustrates an example user interface 840 of the application 800 that displays example information about event and ticket inventory. The user interface 840 may display upon selection of, for example, a control element 812. Some embodiments of the user interface 840 can display aggregate data about one or more events, and data about individual events. For example, the user interface 840 can include a section 842 that displays the number of seats available, the number of seats attended, the number of no-shows, and the percentage of no-shows of all of the events. Further, the user interface 840 can include a section 844 that displays the same or similar data (e.g., the number of no-shows, the percentage of no-shows, etc.) for individual events. The user interface 840 can also include a section 846 that displays the same or similar data (e.g., seats available, seats sold, seats attended, no-shows, etc.) for each seat section.

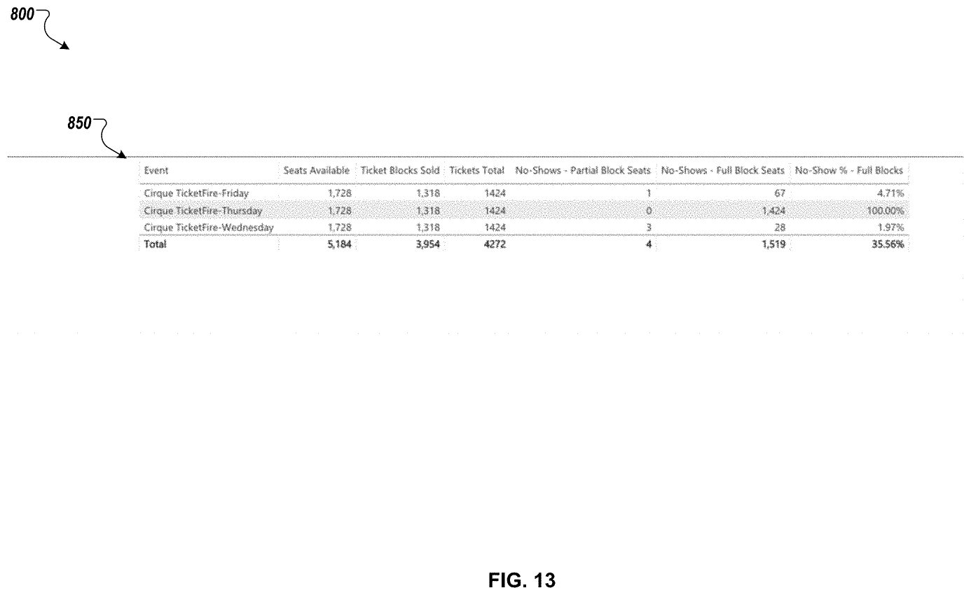

FIG. 13 illustrates an example user interface 850 of the application 800 that displays an example overview of the event results for each event. The overview may present various pieces of information such as seats available, ticket blocks sold, total tickets, no-shows for partial block seats, no-shows for full block seats, percentage of no-shows for full blocks, etc.

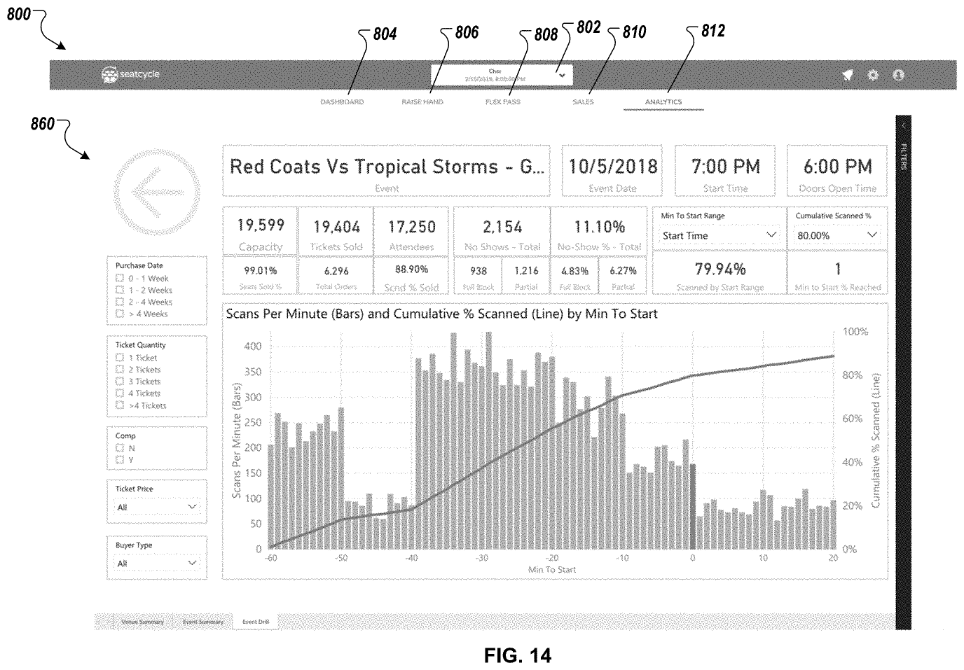

FIG. 14 illustrates an example user interface 860 of the application 800 that displays an example scan report. The scan report may include a graph that illustrates a trend of scanned tickets over time. Other information, such as seats available, tickets sold, no-shows, final no-show percentage, scanned ticket percentage, and other desirable information.

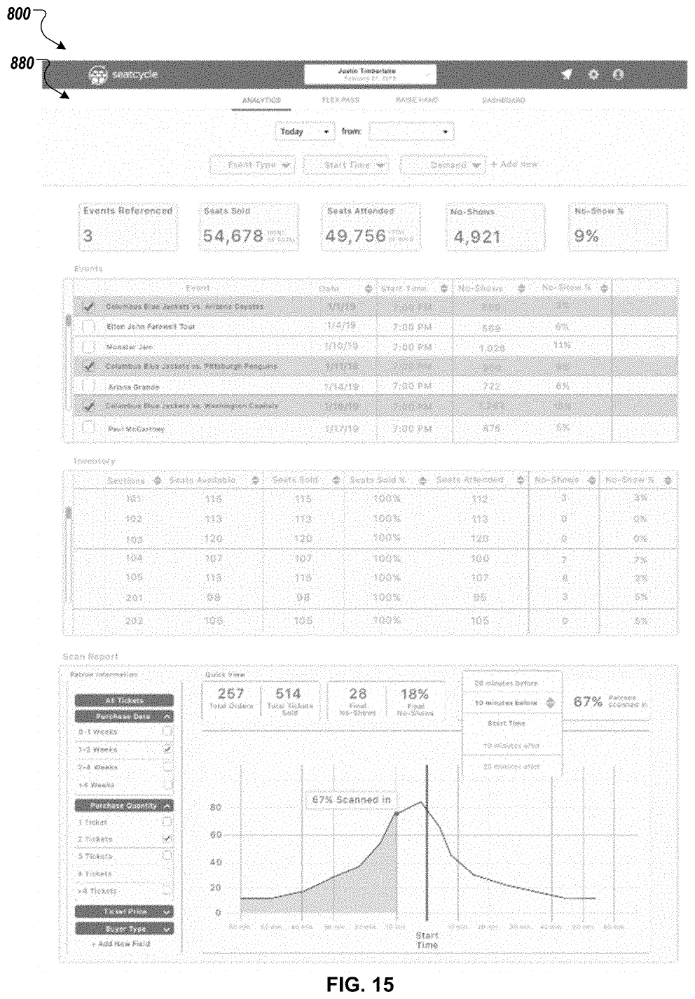

FIG. 15 illustrates an example user interface 880 of the application 800 that provides an example dashboard page. The dashboard page may include various data including event and ticket inventory data, event results, and scan report as illustrated in FIGS. 12-14.

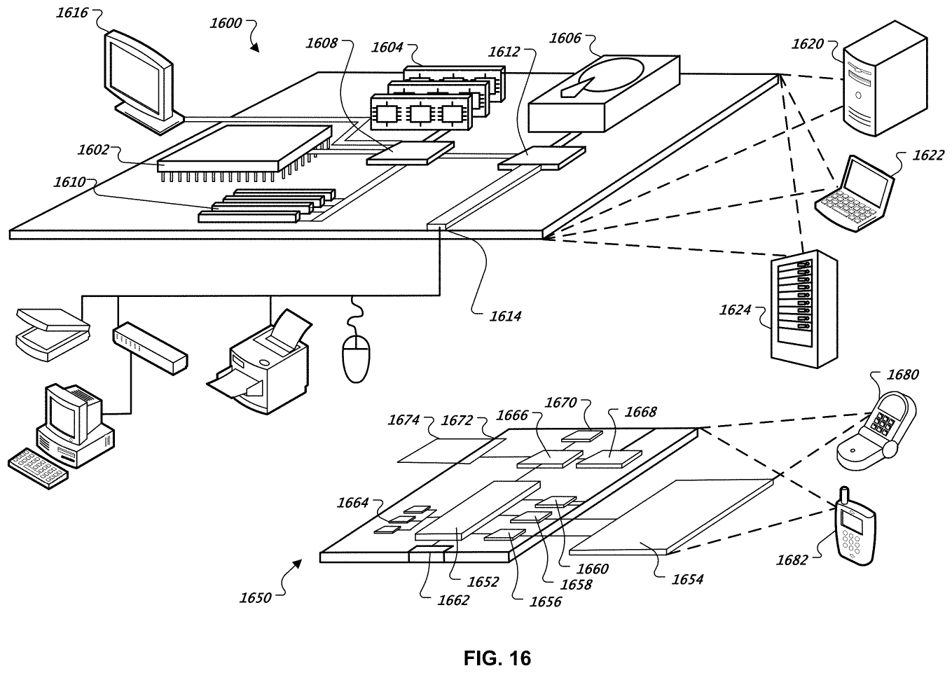

FIG. 16 is a block diagram of computing devices 1600, 1650 that may be used to implement the systems and methods described in this document, as either a client or as a server or plurality of servers. Computing device 1600 is intended to represent various forms of digital computers, such as laptops, desktops, workstations, personal digital assistants, servers, blade servers, mainframes, and other appropriate computers. Computing device 1650 is intended to represent various forms of mobile devices, such as personal digital assistants, cellular telephones, smartphones, and other similar computing devices. The components shown here, their connections and relationships, and their functions, are meant to be examples only, and are not meant to limit implementations described and/or claimed in this document.

Computing device 1600 includes a processor 1602, memory 1604, a storage device 1606, a high-speed interface 1608 connecting to memory 1604 and high-speed expansion ports 1610, and a low speed interface 1612 connecting to low speed bus 1614 and storage device 1606. Each of the components 1602, 1604, 1606, 1608, 1610, and 1612, are interconnected using various busses, and may be mounted on a common motherboard or in other manners as appropriate. The processor 1602 can process instructions for execution within the computing device 1600, including instructions stored in the memory 1604 or on the storage device 1606 to display graphical information for a GUI on an external input/output device, such as display 1616 coupled to high-speed interface 1608. In other implementations, multiple processors and/or multiple buses may be used, as appropriate, along with multiple memories and types of memory. Also, multiple computing devices 1600 may be connected, with each device providing portions of the necessary operations (e.g., as a server bank, a group of blade servers, or a multi-processor system).

The memory 1604 stores information within the computing device 1600. In one implementation, the memory 1604 is a volatile memory unit or units. In another implementation, the memory 1604 is a non-volatile memory unit or units. The memory 1604 may also be another form of computer-readable medium, such as a magnetic or optical disk.

The storage device 1606 is capable of providing mass storage for the computing device 1600. In one implementation, the storage device 1606 may be or contain a computer- readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1604, the storage device 1606, or memory on processor 1602.

The high-speed controller 1608 manages bandwidth-intensive operations for the computing device 1600, while the low speed controller 1612 manages lower bandwidth-intensive operations. Such allocation of functions is an example only. In one implementation, the high-speed controller 1608 is coupled to memory 1604, display 1616 (e.g., through a graphics processor or accelerator), and to high-speed expansion ports 1610, which may accept various expansion cards (not shown). In the implementation, low-speed controller 1612 is coupled to storage device 1606 and low-speed expansion port 1614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1600 may be implemented in a number of different forms, as shown in the figure. For example, it may be implemented as a standard server 1620, or multiple times in a group of such servers. It may also be implemented as part of a rack server system 1624. In addition, it may be implemented in a personal computer such as a laptop computer 1622. Alternatively, components from computing device 1600 may be combined with other components in a mobile device (not shown), such as device 1650. Each of such devices may contain one or more of computing device 1600, 1650, and an entire system may be made up of multiple computing devices 1600, 1650 communicating with each other.

Computing device 1650 includes a processor 1652, memory 1664, an input/output device such as a display 1654, a communication interface 1666, and a transceiver 1668, among other components. The device 1650 may also be provided with a storage device, such as a microdrive or other device, to provide additional storage. Each of the components 1650, 1652, 1664, 1654, 1666, and 1668, are interconnected using various buses, and several of the components may be mounted on a common motherboard or in other manners as appropriate.

The processor 1652 can execute instructions within the computing device 1650, including instructions stored in the memory 1664. The processor may be implemented as a chipset of chips that include separate and multiple analog and digital processors. Additionally, the processor may be implemented using any of a number of architectures. For example, the processor may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 1650, such as control of user interfaces, applications run by device 1650, and wireless communication by device 1650.

Processor 1652 may communicate with a user through control interface 1658 and display interface 1656 coupled to a display 1654. The display 1654 may be, for example, a TFT (Thin-Film-Transistor Liquid Crystal Display) display or an OLED (Organic Light Emitting Diode) display, or other appropriate display technology. The display interface 1656 may comprise appropriate circuitry for driving the display 1654 to present graphical and other information to a user. The control interface 1658 may receive commands from a user and convert them for submission to the processor 1652. In addition, an external interface 1662 may be provide in communication with processor 1652, so as to enable near area communication of device 1650 with other devices. External interface 1662 may provided, for example, for wired communication in some implementations, or for wireless communication in other implementations, and multiple interfaces may also be used.

The memory 1664 stores information within the computing device 1650. The memory 1664 can be implemented as one or more of a computer-readable medium or media, a volatile memory unit or units, or a non-volatile memory unit or units. Expansion memory 1674 may also be provided and connected to device 1650 through expansion interface 1672, which may include, for example, a SIMM (Single In Line Memory Module) card interface. Such expansion memory 1674 may provide extra storage space for device 1650, or may also store applications or other information for device 1650. Specifically, expansion memory 1674 may include instructions to carry out or supplement the processes described above, and may include secure information also. Thus, for example, expansion memory 1674 may be provide as a security module for device 1650, and may be programmed with instructions that permit secure use of device 1650. In addition, secure applications may be provided via the SIMM cards, along with additional information, such as placing identifying information on the SIMM card in a non- hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1664, expansion memory 1674, or memory on processor 1652 that may be received, for example, over transceiver 1668 or external interface 1662.

Device 1650 may communicate wirelessly through communication interface 1666, which may include digital signal processing circuitry where necessary. Communication interface 1666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1668. In addition, short-range communication may occur, such as using a Bluetooth, WiFi, or other such transceiver (not shown). In addition, GPS (Global Positioning System) receiver module 1670 may provide additional navigation- and location-related wireless data to device 1650, which may be used as appropriate by applications running on device 1650.

Device 1650 may also communicate audibly using audio codec 1660, which may receive spoken information from a user and convert it to usable digital information. Audio codec 1660 may likewise generate audible sound for a user, such as through a speaker, e.g., in a handset of device 1650. Such sound may include sound from voice telephone calls, may include recorded sound (e.g., voice messages, music files, etc.) and may also include sound generated by applications operating on device 1650.

The computing device 1650 may be implemented in a number of different forms, as shown in the figure. For example, it may be implemented as a cellular telephone 1680. It may also be implemented as part of a smartphone 1682, personal digital assistant, or other similar mobile device.

Additionally computing device 1600 or 1650 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer- readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub- combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for allocating digital tickets for an event, the method comprising:
obtaining ticket sales data including a number of distributed event tickets;
predicting a number of no-shows among the distributed event tickets;
determining a number of flexible tickets to be distributed, the flexible tickets having no seat assignments,
obtaining, from at least one event venue computing device, real-time ticket scan data including a scan status of the distributed event tickets;
identifying unscanned event tickets among the distributed event tickets based on the real- time ticket scan data by a predetermined time;
assigning seats for the unscanned event tickets to the flexible tickets; and
transmitting a notification of the seat assignments to flexible ticketholder computing devices.

2. The method of claim 1, wherein predicting a number of no-shows comprises:
obtaining historical data including at least one of a historical number of no-shows for the event in history; and
estimating the number of no-shows based at least in part on the historical data.

3. The method of claim 1, wherein predicting a number of no-shows comprises:
obtaining event-related data; and
operating a statistical analysis model based on the event-related data to predict the number of no-shows for the event.

4. The method of claim 3, wherein the event-related data include at least one of historical data relating to a subject event or similar or comparable events, ticket types, patron information, event time, event data, event venue, ticket demand, industry trends, weather information, customer origin location, current customer location, historical no-shows for repeat customers, current ticket sales figures, event and performer social media mentions, secondary marketplace demand, secondary marketplace prices, traffic, event promotions, conflicting events, and competitor pricing, wherein the historical data include at least one of historical ticket sales, historical ticket scans, and historical attendance and/or no-show rates.

5. The method of claim 1, wherein the flexible tickets are allocated at lower prices than the distributed event tickets.

6. The method of claim 1, wherein the flexible tickets are classified into a plurality of categories being distributed at different prices.

7. The method of claim 1, wherein the flexible ticketholder computing devices include mobile computing devices.

8. The method of claim 7, wherein the notification is in a form of text message.

9. The method of claim 1, wherein the notification is transmitted shortly before, at, or shortly after, the event starts.

10. The method of claim 1, further comprising:
determining at least one of the unscanned event tickets is scanned after the notification is transmitted;
assigning other available seats to the flexible tickets; and
transmitting a second notification of the seat assignment to the flexible ticketholder computing devices.

11. The method of claim 1, further comprising:
determining that upgrade seats are available after the notification is transmitted;
assigning the upgrade seats to the flexible tickets; and
transmitting a third notification of the seat assignment to the flexible ticketholder computing devices.

12. The method of claim 1, further comprising:
identifying at least one ticketholder of the distributed event tickets;
transmitting a correspondence to at least one ticketholder computing device before the event starts, the correspondence prompting the at least one ticketholder to provide attendance status;
receiving, from the at least one ticketholder computing device, identification of returned tickets among the distributed event tickets; and
enabling the returned tickets available for distribution.

13. The method of claim 12, further comprising:
upon receiving the identification of returned tickets, providing a compensation to the at least one ticketholder.

14. The method of claim 12, wherein identifying at least one ticketholder comprises:
obtaining event-related data; and
determining the at least one ticketholder that is more likely to return tickets than other ticketholders of the distributed event tickets.

15. The method of claim 1, wherein the number of flexible tickets are less than the predicted number of no-shows.

16. A system for managing allocation of event tickets, the system comprising:
a data processing apparatus; and
a memory device storing instructions that when executed by the data processing apparatus cause the server to perform operations comprising:
obtaining ticket sales data including a number of distributed event tickets;
predicting a number of no-shows among the distributed event tickets;
determining a number of flexible tickets to be distributed, the flexible tickets having no seat assignments,
obtaining, from at least one event venue computing device, real-time ticket scan data including a scan status of the distributed event tickets;
identifying unscanned event tickets among the distributed event tickets based on the real-time ticket scan data by a predetermined time;
assigning seats for the unscanned event tickets to the flexible tickets; and
transmitting a notification of the seat assignments to flexible ticketholder computing devices.

17. A system comprising:
an event venue server configured to communicate one or more ticket scanners and obtain ticket scan data in real-time;
a plurality of ticketholder computing devices each configured to receive regular ticket data and output an electronic regular ticket based on the regular ticket data, the electronic regular ticket configured to be scanned by the one or more ticket scanners;
one or more flexible ticketholder computing devices each configured to receive flexible ticket data and output an electronic flexible ticket based on the flexible ticket data, the electronic flexible ticket configured to be scanned by the one or more ticket scanners; and
a ticket allocation system comprising:
a data processing apparatus; and
a memory device storing instructions that when executed by the data processing apparatus cause the ticket allocation system to perform operations comprising:
obtaining ticket sales data including a number of distributed event tickets;
predicting a number of no-shows among the distributed event tickets;
determining a number of flexible tickets to be distributed, the flexible tickets having no seat assignments;
receiving a purchase request of a flexible ticket from each of the flexible ticketholder computing devices;
transmitting flexible ticket data to each of the flexible ticketholder computing devices, the flexible ticket data representing a flexible ticket identified by the purchase request;
obtaining, from the event venue server, real-time ticket scan data including a scan status of the distributed event tickets;
identifying an unscanned event ticket among the distributed event tickets based on the real-time ticket scan data by a predetermined time;
assigning a seat for the unscanned event ticket to the flexible ticket; and
transmitting a notification of the seat assignment to the flexible ticketholder computing device having the flexible ticket.
